(19) United States
(12) Patent Application Publication
(10) Pub. No.: US 2010/0078373 A1
(43) Pub. Date: Apr. 1, 2010

(54) SUBMERSIBLE MEDIA-FILLED WASTEWATER TREATMENT FILTER

(76) Inventors: Kevin R. Chaffee, Batesville, IN (US); Patrick W Hanlon, Sunman, IN (US)

Correspondence Address: INNOVATION LAW OFFICE OF DENNIS SCHELL, 133 WEST MARKET STREET # 256, INDIANAPOLIS, IN, 46204, US

(21) Appl. No.: 12/523,860

(22) PCT Filed: Jan. 20, 2008
(86) PCT No.: PCT/US08/51535

§ 371 Date: Jul. 20, 2009

Related U.S. Application Data
(60) Provisional application No. 60/881,623, filed on Jan. 20, 2007.
(60) Provisional application No. 60/932,261, filed on May 30, 2007.

(51) Int. Cl. B01D 25/38

(52) U.S. Cl. 210/226

(57) ABSTRACT

An submersible media-filled wastewater treatment filter (18) for use with a septic tank (10) or other treatment unit utilizes a special media (30) to provide solids separation and biological treatment within the filter unit. The media is a highly compressible material with a large surface area to volume ratio. As microorganisms that provide biological treatment of the wastewater flowing therethough grow and multiply in the filter media, the pores of the media may become clogged with biomass and require flushing. The filter provides for in place regeneration of the media. For example, a tool (38) can be used from above the ground surface to compress the media (30), thus flushing the accumulated solids out of the filter media and into the tank (10) in which it is installed.

### CROSS-REFERENCE TO RELATED APPLICATIONS

This application claims the benefits of US Provisional Patent Applications Ser. No. 60/881,623, filed Jan. 20, 2007 and titled ADVANCED SEPTIC TANK WASTEWATER TREATMENT APPARATUS, and Ser. No. 60/932,261, filed May 30, 2007 and titled SEPTIC TANK EFFLUENT FILTER, which are incorporated herein by reference.

### BACKGROUND

The present invention relates to wastewater treatment systems, and more specifically, to filters for septic tanks and other wastewater treatment systems.

The septic tank is part of a conventional onsite wastewater system which includes the septic tank and soil treatment area. According to the U.S. EPA Onsite Wastewater Treatment Systems Manual, approximately 23 percent of the estimated 115 million occupied homes in the United States are served by onsite wastewater systems, a proportion that has changed little since 1970. More than 60 million people depend on onsite wastewater systems, including the residents of about one-third of new homes and more than half of all mobile homes nationwide.

Conventional residential septic tanks generally consist of a concrete, fiberglass or polyethylene tanks buried below grade. The design of the tank typically incorporates one or two compartments and has an inlet pipe at one end and an outlet pipe on the other. Wastewater enters the tank, allowing solids to settle and scum to float. The settled solids are anaerobically digested over time, reducing the volume of solids. The liquid from the center zone of the tank flows through an outlet tee and is typically discharged to a soil treatment area for additional treatment prior to groundwater recharge.

A fairly recent improvement to the conventional septic tank has been the addition of effluent filters installed in the tank outlet tee, or as a substitute to the outlet tee. These effluent filters are fairly typical in that they provide a mechanical barrier to block solid particles from leaving the tank during outflow. A typical filter consists of a plastic housing attached to the discharge pipe in the septic tank with an internal removable cartridge installed within. Current filter cartridges typically consist of a plastic shape with a number of filtration slots or bristles designed to capture the solids flowing through or around the cartridge. These conventional filter cartridges eventually plug up and must be periodically removed by hand from the interior of the septic tank and either replaced or cleaned. Cleaning typically involves spraying off the solids and accumulated sludge with a pressure hose back into the septic tank or into an approved receptacle.

In many situations a water hose is not always readily available for cleaning the filter cartridge. Also, the cleaning process may be difficult in cold weather climates due to freezing temperatures. In these conditions the filter cartridge generally must be removed and replaced with a new cartridge. The soiled filter cartridge containing septic tank sludge and solids is a hazardous, disease carrying material that must be properly handled and safely discarded or cleaned.

In order to remove most filter cartridges, a service technician must reach down into the septic tank, grasp the filter cartridge and pull it out of its housing. If the filter is plugged with solids, the water level in the septic tank is usually over the top of the filter, requiring the technician to reach into the raw wastewater to grasp the cartridge. In many instances, the septic tank is buried to a depth that the filter cannot be reached by hand from the surface of the ground. Some current filters are designed such that a section of plastic pipe can be glued into the top of the filter to allow the filter to be pulled out of the casing from the surface; however, this removal pipe routinely fails to remain in the filter cartridge. Also, the filters routinely become tilted due to pipe settlement and the pipe becomes useless in removing the cartridge due to the angle of the filter in comparison to the access opening of the tank.

The effluent from a typical septic tank is generally distributed into the soil for further treatment and disposal. Many conventional septic systems fail over time due to soil plugging caused by hydraulic and/or organic overloading. According to the U.S. EPA Onsite Wastewater Treatment Systems Manual, a survey conducted by the U.S. Census Bureau estimated that over 400,000 homes experienced failures within a 3-month period during 1997. Studies reviewed by USEPA cite overall failure rates ranging from 10 to 20 percent or greater. System failure surveys typically do not include systems that might be contaminating surface or ground water, a situation that often is detectable only through site-level monitoring.

Two of the primary causes of conventional onsite wastewater treatment system failure are hydraulic overloading and soil plugging due to a clogging biomat. Hydraulic overloading occurs when a larger amount of water flows into a subsurface soil treatment area than can be moved by gravity through the soil. The soil becomes saturated and effluent is forced to the surface without being adequately treated. In extreme situations, wastewater can back up in the septic tank and into the home. Poorly drained soils, high periods of water use, improper design/construction, or leaky septic tanks may cause hydraulic overloading.

Septic tanks provide primary wastewater treatment by separating solid and floating materials from the semi-clear effluent. Even when effluent filters are used, the resulting septic tank effluent remains high in organics and solids content. These organics and solids are discharged to the subsurface soil treatment area where they form an anaerobic layer or “biomat” within the soil. This biomat may eventually restrict flow into the soil (a clogging biomat) which forces the effluent to backup or surface without adequate treatment.

Several studies have shown that septic tank effluent treated to higher standards prior to soil disposal dramatically reduces the failure rate of conventional onsite systems. Converse and Tyler evaluated the effect of highly pretreated effluent on soil loading rates and separation distances to groundwater and/or limiting layers. Field data was collected from a number of septic tanks followed by advanced pretreatment units. These advanced pretreatment units, such as sand filters, recirculating sand filters, peat filters, and aerobic treatment units, reduced organics and solids concentrations allowing higher soil loading rates than if septic tank effluent was applied directly.

Based on the many studies showing the positive effects of increased treatment prior to subsurface soil dispersal, it is apparent that conventional onsite system failure can be dramatically reduced by improved treatment and higher quality effluent being discharged to the soil. Better treatment will allow higher soil loading rates which will reduce hydraulic overloading. Better treatment will also substantially reduce the formation of a clogging biomat in the soil treatment area by reducing organic and solids concentrations in the effluent applied to the soil.

The onsite wastewater industry has accepted the concept of improved treatment and there are a number of available technologies to provide higher quality treatment of septic tank effluent prior to subsurface soil dispersal. Aerobic treatment units, media filters, and constructed wetlands are all common onsite wastewater treatment technologies which have been available for several years. These systems have not been widely used due to their complexity, cost, and extensive maintenance requirements. Based on available data, over 92% of all permitted onsite wastewater systems in the U.S. are still conventional septic systems consisting of a septic tank and soil treatment area.

The conventional septic tank effluent filter provides only physical separation of solids by controlling the size of opening through which the effluent must pass. Most filters employ a 1/16″ (1.6 mm) slot in a plastic filter cartridge to provide said separation. Some filter cartridges rely on a number of bristles to create a passageway to trap the solids exiting the septic tank. These conventional filters provide no biological treatment of the effluent leaving the septic tank.

The typical conventional septic tank provides reduction of biochemical oxygen demand (BOD), a measurement of the organic strength of the wastewater, of about 30-50%, reducing typical domestic strength wastewater from about 300 milligrams per liter (mg/l) to about 150 mg/l (30 day average). The typical conventional septic tank provides reduction of total suspended solids (TSS), a measurement of the amount of solid material suspended in the wastewater, of about 60-90%, reducing typical domestic strength wastewater from about 300 mg/l to about 75 mg/l (30 day average).

If organic and solids loading to the soil disposal field were reduced by better treatment in the septic tank, the soil disposal field would be less prone to plugging and eventual failure. Many states recognize this and allow a reduced field size if the effluent is more highly treated prior to soil discharge. Currently, aerobic treatment units and recirculating or single pass media filters are common types of mechanical treatment technologies that are used to provide higher treatment quality than a typical septic tank equipped with a conventional effluent filter can provide. All of these processes use aerobic bacteria for treatment, are more complex than a conventional septic tank, and require mechanical equipment such as pumps and air blowers to operate. All of these systems require electrical power to operate and require much more service and maintenance than conventional septic tanks. Therefore, the need exists for an improved method of treatment that retains the operational simplicity of the conventional septic tank, requires no mechanical equipment or electrical power to treat the wastewater, and produces better effluent quality than that of a standard septic tank equipped with a conventional effluent filter.

### SUMMARY

The present invention may comprise one or more of the features recited in the attached claims, and/or one or more of the following features and combination thereof.

An illustrative submersible media-filled wastewater treatment filter according to the present disclosure can be installed within a septic tank or other treatment unit, provides enhanced solids separation and anaerobic biological treatment, is able to be flushed when required, and is capable of being serviced without removal from and without entering the tank in which it is installed. The illustrative filter provides enhanced solids separation and biological treatment of the effluent passing through it.

An illustrative embodiment of the filter eliminates the requirement to remove the filter cartridge for cleaning by allowing the filter to be cleaned in place from the ground surface using a tool designed for flushing the filter when required. The service technician will no longer be required to reach into a flooded tank full of wastewater to remove a filter cartridge, or try and remove a filter cartridge from a filter that is tilted due to pipe settlement. The technician will no longer have to complete the unsanitary process of washing solids and sludge from a filter cartridge in a dangerous confined space within the opening of a septic tank. The technician will also no longer have to dispose of soiled filter cartridges removed from the septic tank.

A septic tank with a filter according to the present disclosure installed has increased BOD reduction to over 81% and TSS reduction to over 95% in actual performance testing.

Filters according to the present disclosure utilize a special media to provide solids separation and biological treatment within the filter unit. The media is a compressible material with a large amount of surface area in relation to its volume. The media provides a physical barrier to the passage of solids as well as an attached growth surface for microorganisms to collect and grow. The attached microorganisms will treat the wastewater flowing through the filter by a combination of physical, chemical and biological processes. As the microorganisms grow and multiply, the pores of the filter media will eventually become clogged with biomass and require flushing. The filter media will be flushed by compressing the filter media with a tool from the ground surface, squeezing the media and pushing the accumulated solids back into the tank in which it is installed. The flushing intervals will be determined by the pore space of the selected media and the loading characteristics of the wastewater treatment system.

An illustrative embodiment of a wastewater treatment filter according to the present disclosure comprises: a casing having an interior void defined therein; a compressible media located in the interior void, the media having a porous structure providing an increased surface area to volume ratio; a first support member adapted to retain the media within the interior void on at least a first end of the media; and a second support member movably associated with the casing and adapted to retain the media within the interior void on at least a second end of the media, the second end located substantially opposite the first end; wherein the second support member is movable toward the first support member thereby compressing the media. The wastewater treatment filter wherein the media includes reticulated foam. The wastewater treatment filter wherein the first support member defines openings therethough, the openings sized to facilitate the passage of wastewater and biomass. The wastewater treatment filter wherein the first support member includes a rigid grating. The wastewater treatment filter wherein the second support member defines openings therethough, the openings sized to facilitate the passage of wastewater and biomass. The wastewater treatment filter wherein the second support member includes a rigid grating. The wastewater treatment filter of claim 1, wherein the second support member is located adjacent a top portion of the casing and is associated with the casing so that it is slideable along the length of the casing toward the first support member. The wastewater treatment filter can further comprise at least one inlet opening defined in the casing and wherein the first support member is positioned between the media and the at least one inlet opening. The wastewater treatment filter can further comprise at least one outlet opening defined in the casing, the outlet opening located between the first support member and the second support member. The wastewater treatment filter wherein the outlet opening includes an orifice for restricting the rate of flow therethrough. The wastewater treatment filter wherein the media includes an open cell structure of at least about 15 pores per inch (5.9 pores per cm). The wastewater treatment filter wherein the media has a 25% compression force deflection (CFD) measurement of less than about 0.40 pounds per square inch (0.03 kg/cm). The wastewater treatment filter wherein the media has a compression set at 50% deflection of less than about 15%.

Another illustrative embodiment of a septic tank system according to the present disclosure comprises: a first treatment compartment; a second treatment compartment having an inlet opening in fluid communication with the first treatment compartment; compressible media located in the second treatment compartment, the media having a porous structure providing an increased surface area to volume ratio; and a member movably associated with the second treatment compartment and adapted to retain the media within the second treatment compartment; wherein the member is movable toward the media thereby compressing the media. The septic tank system wherein the first treatment compartment and the second treatment compartment are defined by a dividing wall therebetween. The septic tank system can further include a casing and wherein: the casing defines the second treatment compartment; and the second treatment compartment is located within the first treatment compartment. The septic tank system wherein the media includes reticulated foam. The septic tank system wherein the member defines openings therethough, the openings sized to facilitate the passage of wastewater and biomass. The septic tank system further comprising at least one inlet opening defined in the casing and wherein the at least one inlet opening is located in a clear zone of the first treatment compartment.

Yet another illustrative embodiment of a wastewater treatment filter comprises: a casing having an interior void defined therein; a compressible media located in the interior void, the media having a porous structure providing an increased surface area to volume ratio; a first support member adapted to retain the media within the interior void on at least a first end of the media; and a means for repeatedly compressing the media within the interior void.

Additional features of the disclosure will become apparent to those skilled in the art upon consideration of the following detailed description of the illustrative embodiment.

### BRIEF DESCRIPTION OF THE DRAWINGS

The description of the illustrative embodiments particularly refers to the accompanying figures in which:

FIG. 1A is a perspective view of a typical septic tank with an illustrative embodiment of a filter according to the present disclosure installed inside;

FIG. 1B is a perspective view of the typical septic tank and illustrative filter shown in FIG. 1A with the lid raised above the tank;

FIG. 1C is a top perspective view of the tank and illustrative filter shown in FIG. 1B;

FIG. 2 is a side perspective view of the illustrative filter of FIGS. 1B and 1C and an illustrative flushing tool;

FIG. 3 is a vertical section view of the illustrative filter of FIG. 2;

FIG. 4 is a detail perspective view of the outlet of the illustrative filter of FIG. 2, showing a flow control orifice;

FIG. 5 is a transparent perspective view of the tank and illustrative filter of FIGS. 1-4 being serviced using the illustrative flushing tool of FIG. 2;

FIG. 6A is a side, transparent perspective view of the illustrative filter of FIGS. 1-5 in normal operation; and

FIG. 6B is a side, transparent perspective view of the illustrative filter of FIGS. 1-5 during a filter flush down stroke using the illustrative flushing tool of FIG. 2.

### TABLE 1

### Drawing Reference Numerals

TABLE 1
Drawing Reference Numerals

| No. | Description |
|---|---|
| 10 | Septic Tank |
| 12 | Septic Tank Access Riser and Lid |
| 14 | Inlet Pipe |
| 16 | Inlet Tee |
| 17 | Septic Tank Compartment |
| 18 | Submersible Media-Filled Wastewater Treatment Filter (Filter) |
| 20 | Filter Outlet Pipe |
| 22 | Filter External Casing |
| 24 | Filter Casing Support Legs |
| 26 | Filter Openings Between Support Legs |
| 28 | Filter Media Support Bottom Member |
| 30 | Filter Media |
| 32 | Filter Media Containment Top & Flushing Member (top member) |
| 34 | Septic Tank Outlet Pipe |
| 36 | Filter Outlet Pipe Flow Control Orifice |
| 38 | Filter Flushing Tool |
| 39 | Tool End Member |

### DESCRIPTION OF THE ILLUSTRATIVE EMBODIMENTS

For the purposes of promoting and understanding the principals of the invention, reference will now be made to one or more illustrative embodiments illustrated in the drawings and specific language will be used to describe the same.

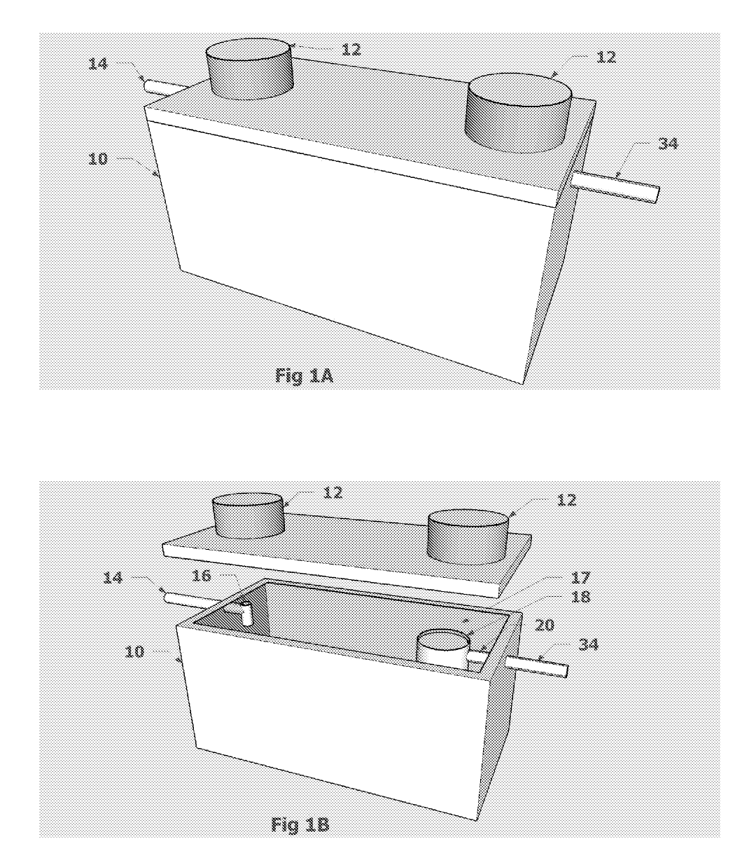

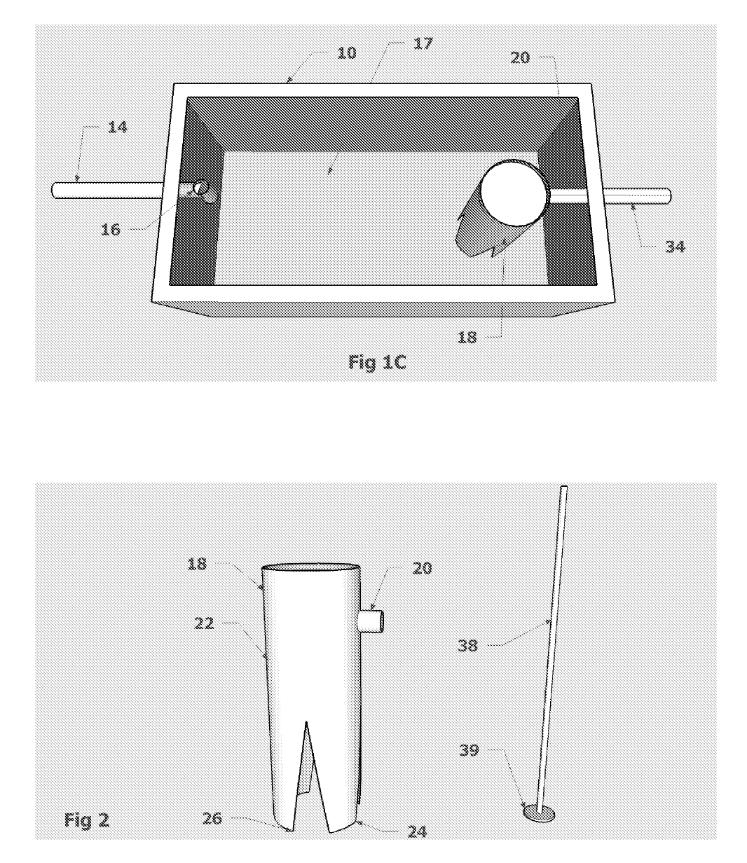

Referring to FIGS. 1A-1C, septic tank 10 is generally installed at the site of the residence or other building. Septic tank 10 is a fully or substantially enclosed vessel constructed of standard septic tank materials such as precast concrete, fiberglass or plastic. Septic tank 10 is typically buried below grade so as to allow flow by gravity from the building to the tank. Domestic wastewater from the residence or building flows into an inlet pipe 14 and falls through the inlet tee 16 into the tank compartment 17. The drop depth of inlet tee 16 is sized so that the untreated wastewater enters the tank below a scum layer of fat, oils and grease floating at the top of wastewater in compartment 17, and above accumulated sludge in the bottom of the tank. The region between the scum and sludge layers is the center clear zone. An access opening riser and lid 12 is located generally over inlet tee 16 to allow access for service of the tee if it becomes clogged and to allow for evacuation pumping of the tank when required. The access risers and lids 12 are typically situated at ground level, fastened in place to prevent unauthorized access, and sealed to prevent the release of gas or odors to the atmosphere.

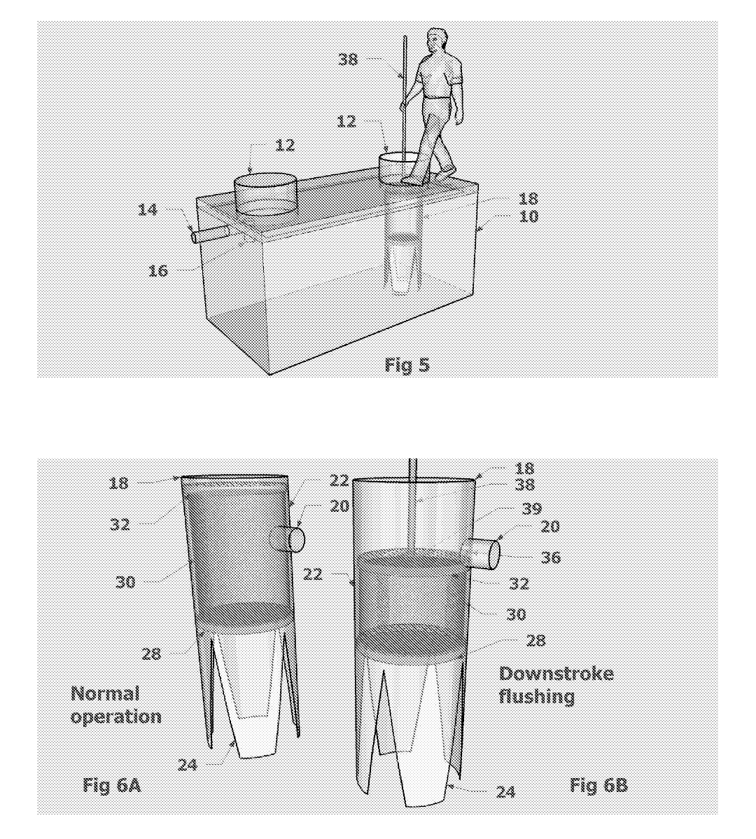

Referring to FIGS. 2 and 5, wastewater entering tank 10 through inlet tee 16 flows laterally through the tank compartment 17 to a submersible media-filled wastewater treatment filter (filter) 18. Water depth in the tank is controlled by the invert elevation of a filter outlet pipe 20 which is typically 1 to 3 inches (2.5 to 7.6 cm) lower than the invert of the inlet pipe 14. Settleable solids fall to the bottom of the tank by gravity as wastewater flows along the length of the tank, and fats, oils and grease float to the surface of the water. An access opening riser and lid 12 is located generally over filter 18 to allow access for service of the filter, for example, when it becomes clogged and to allow for evacuation pumping of the tank when required.

Filter 18 extends downward into the tank compartment 17. Inlet openings 26 defined in filter casing 22 are located at a depth of the tank compartment 17 in the center clear zone, i.e., above the settled sludge layer and below the scum layer. From the center clear zone, water flows into the inlet openings 26 of filter 18 by the head pressure created by the difference in water elevation from the invert of the inlet pipe 14 to the invert of the filter outlet pipe 20.

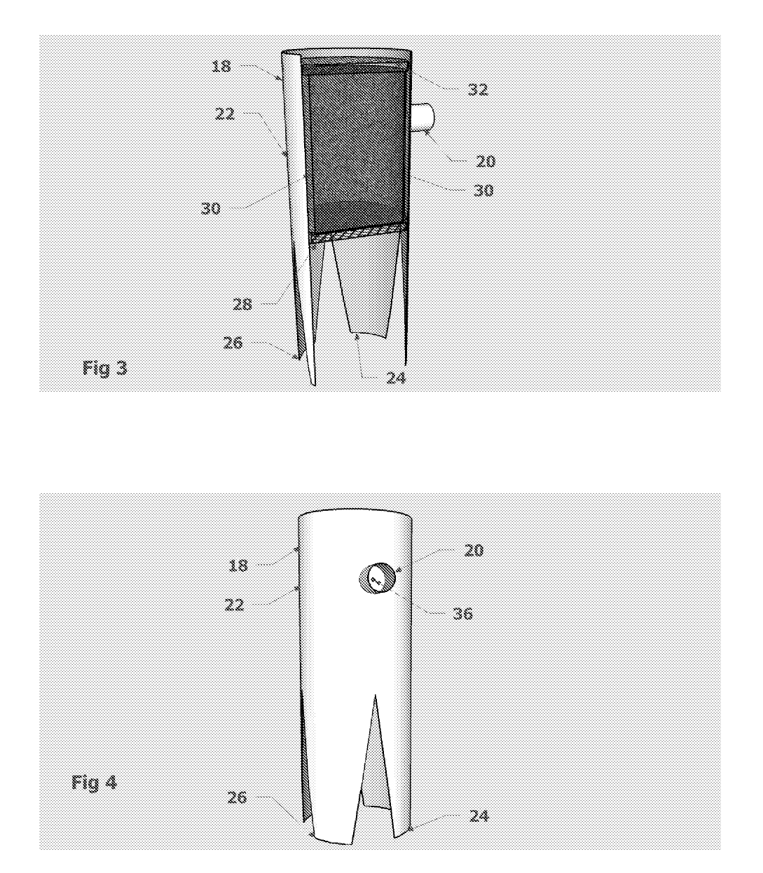

Referring to FIG. 3, settled wastewater flows through filter openings 26 defined between support legs 26. Settled wastewater flows upwards through openings in filter media support member 28, upward through filter media 30, and out filter outlet pipe 20. The illustrative filter media 30 is reticulated foam which is highly compressible, substantially returns to its original shape after compression, and also provides a high surface area per volume of material for attachment of microorganisms. For example, flexible polyether foam having a three-dimensional structure with substantially no cell walls between connecting strands, as is known in the art. Other natural or man-made materials that have similar characteristics may also be employed for filter media 30, for example, materials having an open cell structure of at least about 15 pores per inch (5.9 pores per cm), a 25% compression force deflection (CFD) measurement of less than about 0.40 pounds per square inch (0.03 kg/cm), and a compression set at 50% deflection of less than about 15%.

The filter media 30 may include of a single or multiple portions of homogenous pore size, or include layers of coarser material located at the bottom, progressing to finer material at top to provide enhanced filtration. For example, coarser grade T-15 and finer grade C-20 and C-30 polyether reticulated foam available from Crest Foam Industries, Inc., of Moonachie, N.J., US.

As the wastewater passes through the filter media 30 it is treated by a combination of physical, chemical and biological processes by the microorganisms attached to the media structural surface area. In the case of a septic tank, the microorganisms are typically anaerobic, meaning they do not require oxygen to survive, but for other embodiments the microorganisms may be aerobic if sufficient oxygen is available or supplied to the treatment process at media 30.

After passing through filter media 30, the treated wastewater is discharged from filter 18 through the integral or coupled filter outlet pipe 20. Optionally, a filter outlet pipe flow control orifice 36 (FIG. 4) may be associated with filter 18, for example, located in filter outlet pipe 20, to control the rate of flow from the filter, thus increasing residence time and enhancing treatment. Flow control orifice 36 is a small opening passing through a baffle wall, essentially restricting the size of filter outlet pipe 20 to the diameter of the orifice. The invert of filter outlet pipe 20 is set lower than normal below the invert of septic tank inlet pipe 14 to allow storage of wastewater during periods when flow into septic tank exceeds allowable flow through filter outlet pipe flow control orifice 36. Treated wastewater flowing from filter flow control outlet orifice 36 is directed out septic tank 10 through septic tank outlet pipe 34, which is coupled or integral with filter outlet pipe 20, and is typically discharged to a soil treatment area for additional treatment and groundwater recharge.

Filter media 30 is held in place in the interior void of the filter external casing 22 between the filter media support bottom member 28 and the filter top member 32. The filter media support bottom member 28 can be a perforated plastic, fiberglass or other non-corrosive material, for example, rigid fiberglass grating with about 1 inch (2.5 cm) square openings between cross members. The filter media support bottom member 28 is typically held in place by stainless steel or non-corrosive bolts passing through it and through the filter external casing 22.

Because the filter media 30 is buoyant and tries to float when submerged, top member 32 is installed with stainless steel or non-corrosive bolts fastened through filter external casing 22 above top member 32, holding it in place on top of the filter media 30 and restricting upward movement of the media. The fasteners act as stop points for the top member 32 to prevent filter media 30 and top member 32 from floating out of the filter external casing 22; however, downward movement of top member 32 can be unrestricted. Top member 32 can be constructed of similar materials as filter media support bottom member 28.

When the biomass growth in filter media 30 fills the available media pore space, flow through filter 18 will be reduced, indicating a need to service the filter. To regenerate filter 18, a service technician depresses the filter media containment top and flushing support member (top plate) 32 using a pole or other tool, for example, tool 38 (FIG. 2) having an end member 39 at a distal end. For example, using the tool 38 with end member 39 contacting top member 32, the technician repeatedly pushes down on top member 32, thus compressing media 30, forcing biomass out. For example, the technician repeatedly applies and removes a load on top member 32, thereby alternating between compressing media 30 and allowing media 30 to re-expand to its previous span between top member 32 and support bottom 28. Additionally, the servicing can be completed with or without the flow of a liquid directed to top member 32 to facilitate flushing of the media 30. The technician can perform the flushing operation continuously until filter media 30 is clean and ready to be placed back into service.

During filter media 30 compression, solids and biomass entrained within the media are dislodged and directed out of the media. Solids flushed from the filter media 30 will be discharged through the filter media support bottom member 28 and through filter openings between support legs 26, thereby settling out in the sludge layer in the bottom of the tank basin 17.

Other means for in-place, repeated compressing of the media 30 may be utilized. For example, casing 22 may include other structure for compressing media 30, for example radially compressing media 30. Additionally or alternatively, bottom member 28 can be moved toward top member 32 thereby compressing media 30. An actuator or other device for compressing media 30 may additionally or alternatively be employed.

An illustrative size of filter 18 for a typical septic tank 10 is about 18″ (45.7 cm) diameter and about 50″ (127 cm) tall; however, the size of the filter 18 and volume of media 30 contained therein will vary depending on the size of and flow through septic tank 10, the desired level of filtering, and the type of media 30. The filter media 30 may substantially or entirely fill the interior void of the filter external casing 22 between the filter media support bottom member 28 and the filter top member 32, or open areas may be included between members 28 and 32.

The submersible media-filled wastewater filter described herein will allow service technicians to clean in place without entering the tank, eliminating the unpleasant and potentially dangerous job of cleaning or replacing conventional filter cartridges. The improved effluent filter described herein will also provide enhanced treatment and removal of organic matter and solids from wastewater, thereby providing better protection and longer life for downstream soil treatment areas. Additional uses of our Filter include aerobic treatment units, attached growth denitrification units, and the use of multiple Filters for higher flows.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected. For example, aspects of one illustrative embodiment may also be incorporated with any of the other illustrative embodiments disclosed herein.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected.

1. A wastewater treatment filter (18), comprising:
a casing (22) having an interior void defined therein;
a compressible media (30) located in the interior void, the media having a porous structure providing an increased surface area to volume ratio;
a first support member (28) adapted to retain the media within the interior void on at least a first end of the media; and
a second support member (32) movably associated with the casing and adapted to retain the media within the interior void on at least a second end of the media, the second end located substantially opposite the first end;
wherein the second support member (32) is movable toward the first support member thereby compressing the media.

2. The wastewater treatment filter of claim 1, wherein the media (30) includes reticulated foam.

3. The wastewater treatment filter of claim 1, wherein the first support member (28) defines openings therethough, the openings sized to facilitate the passage of wastewater and biomass.

4. The wastewater treatment filter of claim 3, wherein the first support member (28) includes a rigid grating.

5. The wastewater treatment filter of claim 1, wherein the second support member (32) defines openings therethough, the openings sized to facilitate the passage of wastewater and biomass.

6. The wastewater treatment filter of claim 5, wherein the second support member (32) includes a rigid grating.

7. The wastewater treatment filter of claim 1, wherein the second support member (32) is located adjacent a top portion of the casing and is associated with the casing so that it is slideable along the length of the casing toward the first support member.

8. The wastewater treatment filter of claim 1, further comprising at least one inlet opening (26) defined in the casing and wherein the first support member (28) is positioned between the media (30) and the at least one inlet opening.

9. The wastewater treatment filter of claim 1, further comprising at least one outlet opening (20) defined in the casing, the outlet opening located between the first support member and the second support member.

10. The wastewater treatment filter of claim 9, wherein the outlet opening includes an orifice (36) for restricting the rate of flow therethrough.

11. The wastewater treatment filter of claim 1, wherein the media (30) includes an open cell structure of at least about 15 pores per inch (5.9 pores per cm).

12. The wastewater treatment filter of claim 1, wherein the media (30) has a 25% compression force deflection (CFD) measurement of less than about 0.40 pounds per square inch (0.03 kg/cm).

13. The wastewater treatment filter of claim 1, wherein the media (30) has a compression set at 50% deflection of less than about 15%.

14. A septic tank system, comprising:
a first treatment compartment (17);
a second treatment compartment (18) having an inlet opening (26) in fluid communication with the first treatment compartment;
compressible media (30) located in the second treatment compartment, the media having a porous structure providing an increased surface area to volume ratio; and
a member (32) movably associated with the second treatment compartment and adapted to retain the media within the second treatment compartment;
wherein the member is movable toward the media thereby compressing the media.

15. The septic tank system of claim 14, wherein the first treatment compartment (17) and the second treatment compartment (18) are defined by a dividing wall therebetween.

16. The septic tank system of claim 14, further comprising a casing (22) and wherein:
the casing defines the second treatment compartment (18); and
the second treatment compartment (18) is located within the first treatment compartment (17).

17. The septic tank system of claim 16, wherein the media (30) includes reticulated foam.

18. The septic tank system of claim 16, wherein the member (32) defines openings therethough, the openings sized to facilitate the passage of wastewater and biomass.

19. The septic tank system of claim 16, further comprising at least one inlet opening (26) defined in the casing and wherein the at least one inlet opening is located in a clear zone of the first treatment compartment (17).

20. A wastewater treatment filter (18), comprising:
a casing (22) having an interior void defined therein;
a compressible media (30) located in the interior void, the media having a porous structure providing an increased surface area to volume ratio; and
a means (32) associated with the casing (22) and adapted to repeatedly compress the media (30) within the interior void.
